(19) United States
(12) Patent Application Publication
(10) Pub. No.: US 2014/0250857 A1
(43) Pub. Date: Sep. 11, 2014

(54) LOW-CONCENTRATION METHANE GAS OXIDATION SYSTEM USING EXHAUST HEAT FROM GAS TURBINE ENGINE

(71) Applicant: KAWASAKI JUKOGYO KABUSHIKI KAISHA, Kobe-shi, Hyogo (JP)

(72) Inventors: Shinichi Kajita, Kobe-shi (JP); Yoshihiro Yamasaki, Kobe-shi (JP); Yasufumi Hosokawa, Kakogawa-shi (JP)

(73) Assignee: KAWASAKI JUKOGYO KABUSHIKI KAISHA, Kobe-shi, Hyogo (JP)

(21) Appl. No.: 14/349,910

(22) PCT Filed: Oct. 15, 2012
(86) PCT No.: PCT/JP2012/076597

§ 371 Date: Apr. 4, 2014

(30) Foreign Application Priority Data
Oct. 17, 2011 (JP) 2011-228239

(51) Int. Cl. F02C 6/18

(52) U.S. Cl. CPC F02C 6/18
USPC 60/39.5

(57) ABSTRACT

A low-concentration methane gas oxidation system is provided which effectively uses exhaust heat from a gas turbine engine and is able to avoid burnout of a catalyst etc. to enable stable operation even when a methane concentration in a low-concentration methane gas which is a treatment target is rapidly increased. In a low-concentration methane gas oxidation system which oxidizes a low-concentration methane gas by using exhaust heat from a gas turbine engine, a supply source of the low-concentration methane gas which is an oxidation treatment target, a catalyst layer configured to oxidize the low-concentration methane gas by catalytic combustion, and an intake damper connected to a supply passage through which the low-concentration methane gas is supplied from the supply source to the catalyst layer and configured to introduce an air from an outside into the supply passage, are provided.

### CROSS REFERENCE TO THE RELATED APPLICATION

This application is based on and claims Convention priority to Japanese patent application No. 2011-228239, filed Oct. 17, 2011, the entire disclosure of which is herein incorporated by reference as a part of this application.

### BACKGROUND OF THE INVENTION

1. Field of the Invention

The present invention relates to a system which oxidizes a low-concentration methane gas such as VAM (Ventilation Air Methane) or CMM (Coal Mine Methane) generated from a coal mine.

2. Description of Related Art

In order to reduce greenhouse effect gases, it is necessary to oxidize a low-concentration methane gas such as VAM or CMM discharged from a coal mine to the atmosphere. As such an oxidation apparatus, hitherto, a system is known in which a lean fuel gas turbine is combined with catalytic combustion (See, for example, Patent Document 1.). In the example disclosed in Patent Document 1, a low-concentration methane gas is heated to a catalytic reaction temperature by using exhaust heat from a gas turbine, is caused to flow to a catalyst layer, and is burned there.

### PRIOR ART DOCUMENT

[Patent Document 1] Japanese Patent No. 4538077

### SUMMARY OF THE INVENTION

However, the methane concentration of VAM or CMM may be greatly varied. Thus, in an existing oxidation apparatus, it is difficult to follow change in the concentration of the low-concentration methane gas, burnout of a catalyst may occur when the concentration is rapidly increased, and stable operation of the apparatus is difficult.

Therefore, an object of the present invention is to provide, in order to solve the above-described problem, a low-concentration methane gas oxidation system which effectively uses exhaust heat from a gas turbine engine and is able to avoid burnout of a catalyst to enable stable operation even when a methane concentration in a low-concentration methane gas which is a treatment target is rapidly increased.

In order to achieve the above-described object, a low-concentration methane gas oxidation system according to the present invention is a low-concentration methane gas oxidation system to oxidize a low-concentration methane gas by using exhaust heat from a gas turbine engine, the system including: a supply source of the low-concentration methane gas, which is an oxidation treatment target; a catalyst layer configured to oxidize the low-concentration methane gas by catalytic combustion; and an intake damper connected to a supply passage through which the low-concentration methane gas is supplied from the supply source to the catalyst layer and configured to introduce an air from an outside into the supply passage when a methane concentration within the supply passage is higher than a predetermined value.

According to the configuration, it is possible to effectively use the exhaust heat from the gas turbine engine, and it is possible to lower the methane concentration by introducing the air via the intake damper even when the concentration of the low-concentration methane gas is rapidly increased. Thus, it is possible to avoid burnout of a catalyst etc. to stably operate the system.

In one embodiment of the present invention, the supply passage may be connected with a blow-off valve configured to release a gas within the supply passage to an outside when the methane concentration within the supply passage is higher than a predetermined value. According to this configuration, when the methane concentration is not reduced within the predetermined value even by the introduction of the air from the intake damper, it is possible to release the low-concentration gas to the outside by opening the blow-off valve, and thus it is possible to more assuredly avoid burnout of the catalyst etc.

In one embodiment of the present invention, the gas turbine engine may be a lean fuel intake gas turbine which uses, as a working gas, the low-concentration methane gas supplied from the supply source, and the intake damper may be connected to a downstream side of a branch point that ramifies from the supply passage a branch supply passage to supply the low-concentration gas to the gas turbine engine. According to this configuration, even when the air is introduced into the supply passage, it is possible to avoid lowering of the concentration of the working gas G1 supplied to the gas turbine engine, which is a supply source of heat used for the oxidation treatment, and thereby decreasing of output of the gas turbine engine.

In addition, a low-concentration methane gas oxidation method according to the present invention is a low-concentration methane gas oxidation method for oxidizing a low-concentration methane gas by using exhaust heat from a gas turbine engine, the low-concentration methane gas oxidation method including: oxidizing the low-concentration methane gas supplied from a supply source, by catalytic combustion; and introducing an air from an outside into a supply passage through which the low-concentration methane gas is supplied from the supply source, when a methane concentration within the supply passage is higher than a predetermined value. According to this configuration, it is possible to effectively use the exhaust heat from the gas turbine engine, and it is possible to lower the methane concentration by introducing the air into the supply passage even when the concentration of the low-concentration methane gas is rapidly increased. Thus, it is possible to avoid burnout of a catalyst etc. to stably operate the system.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic configuration of a low-concentration methane gas oxidation system according to a first embodiment of the present invention; and

FIG. 2 is a block diagram showing a schematic configuration of a low-concentration methane gas oxidation system according to a second embodiment of the present invention.

### DESCRIPTION OF EMBODIMENTS

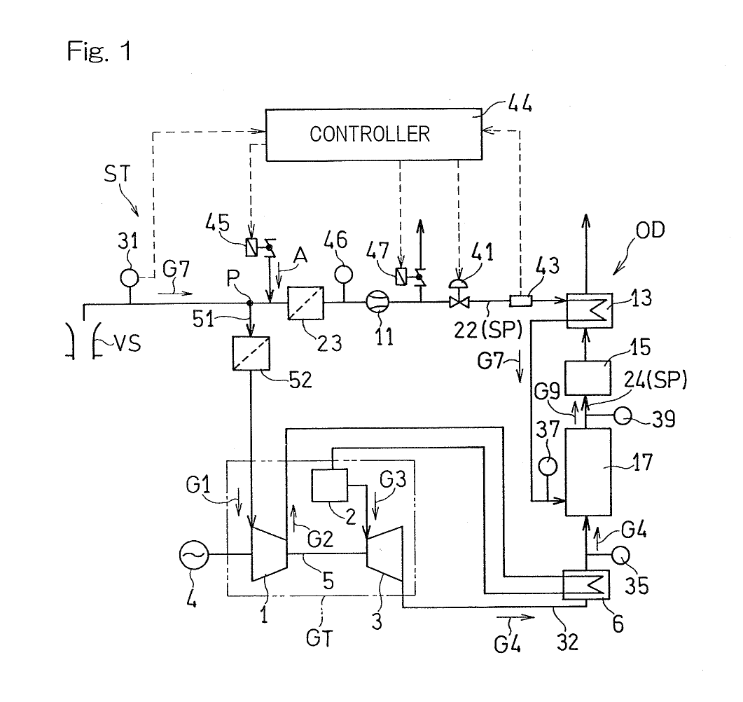

Hereinafter, embodiments of the present invention will be described with reference to the drawings. FIG. 1 is a schematic configuration diagram showing a low-concentration methane gas oxidation system (hereinafter, referred to merely as “oxidation system”) ST according to a first embodiment of the present invention. The oxidation system ST oxidizes a low-concentration methane gas, such as VAM discharged from a coal mine, in a low-concentration methane gas oxidation device OD by using exhaust heat from a gas turbine engine GT.

In the embodiment, a lean fuel intake gas turbine which uses, as a fuel, a combustible component contained in a low-concentration methane gas is used as the gas turbine GT, and VAM, which is a low-concentration methane gas from a shared VAM supply source VS, is supplied to the low-concentration methane gas oxidation device OD and the gas turbine GT as described later. The gas turbine GT includes a compressor 1, a combustor 2 which is a catalytic combustor including a catalyst such as platinum, palladium, or the like, and a turbine 3. A load such as a generator 4 is driven by output of the gas turbine GT.

As a low-calorie gas used in the gas turbine GT, a working gas G1 which is a low-concentration methane gas such as VAM or CMM generated from a coal mine is introduced into the gas turbine GT via an intake port of the compressor 1. The working gas G1 is compressed by the compressor 1 into a high-pressure compressed gas G2, and the high-pressure compressed gas G2 is sent to the catalytic combustor 2. The compressed gas G2 is burned by a catalytic reaction with the catalyst of the catalytic combustor 2 such as platinum, palladium, or the like, and the resulting high-temperature and high-pressure combustion gas G3 is supplied to the turbine 3 to drive the turbine 3. The turbine 3 is connected to the compressor 1 via a rotation shaft 5, and the compressor 1 and the generator 4 are driven by the turbine 3.

The gas turbine GT further includes a first heat exchanger 6 which heats the compressed gas G2 to be introduced from the compressor 1 into the catalytic combustor 2, using an exhaust gas G4 from the turbine 3. The exhaust gas G4 having passed through the first heat exchanger 6 as a heating medium is sent to the low-concentration methane gas oxidation device OD. The exhaust gas G4 from the first heat exchanger 6 contains, in addition to an unburned methane gas having passed from the catalytic combustor 2 through the inside of the turbine 3, a low-concentration methane gas used to cool the shaft of the turbine 3 and a low-concentration gas which leaks from minute gaps between components forming the gas turbine GT.

The low-concentration methane gas oxidation device OD includes a blower 11, a second heat exchanger 13, a catalyst layer 15, and a mixer 17. The blower 11, the second heat exchanger 13, and the mixer 17 are provided on a low-concentration gas passage 22 forming a supply passage SP for supplying a low-concentration gas G7, which is an oxidation treatment target, to the catalyst layer 15. The low-concentration gas G7 supplied from the VAM supply source VS flows past an oxidation device side filter 23 through the low-concentration gas passage 22, and then is sent to the second heat exchanger 13 by the blower 11. The low-concentration gas G7 heated by the second heat exchanger 13 is mixed with a high-temperature exhaust gas G5 from the gas turbine GT, within the mixer 17. A mixed gas G9 resulting from the mixing in the mixer 17 flows through a mixed gas discharge passage 24 which forms the supply passage SP, and enters the catalyst layer 15 which performs oxidation treatment by catalytic combustion. The mixed gas G9 is oxidized in the catalyst layer 15, and subsequently heats the low-concentration gas G7 in the second heat exchanger 13, and is discharged to the outside of the system.

The VAM supply source VS is provided with at the downstream side thereon a first methane concentration sensor 31 for measuring the methane concentration of the low-concentration methane gas G7 supplied from the VAM supply source VS. In addition, first to third temperature sensors 35, 37, and 39 which measure a gas temperature are provided at the upstream side of the mixer 17 on an exhaust gas sending passage 32 from the gas turbine engine GT to the mixer 17, at the upstream side of the mixer 17 on the low-concentration gas passage 22, and between the mixer 17 and the catalyst layer 15 on the mixed gas discharge passage 24, respectively. Furthermore, a flow control valve 41 and a flowmeter 43 are provided between the blower 11 and the second heat exchanger 13 on the low-concentration gas passage 22. Signals indicating measured values of the first methane concentration sensor 31, the temperature sensors 35, 37, and 39, and the flowmeter 43 are inputted to a controller 44, and an aperture of the flow control valve 41 is controlled in accordance with a flow control signal outputted from the controller 44 on the basis of those measured values, whereby a flow rate of the low-concentration gas G7 flowing through the low-concentration gas passage 22 is controlled.

The low-concentration gas passage 22 is connected with an intake damper 45 which introduces outside air A into the low-concentration gas passage 22. When the methane concentration of the low-concentration gas G7, supplied from the VAM supply source VS, which is measured by the first methane concentration sensor 31 is higher than a predetermined value, the intake damper 45 connected to the upstream side of the blower 11 is opened to introduce the air A, thereby lowering the methane concentration. After the air A is introduced from the intake damper 45, the methane concentration is measured by a second methane concentration sensor 46 connected to the upstream side of the blower 11 (between the oxidation device side filter 23 and the blower 11). In addition, a blow-off valve 47 is connected between the blower 11 and the flow control valve 41. When the methane concentration is not reduced within the predetermined value even by the introduction of the air A from the intake damper 45, the blow-off valve 47 is opened on the basis of a blow-off command signal from the controller 44, to release (blow off) the low-concentration gas G7 to the outside.

As described above, the low-concentration gas G7 from the VAM supply source VS is also supplied as a fuel to the gas turbine GT. Specifically, a branch supply passage 51 for supplying the low-concentration gas G7 to the compressor 1 of the gas turbine GT is provided so as to branch from the upstream side of the intake damper 45 on the low-concentration gas passage 22. The low-concentration gas is supplied to the gas turbine GT via the branch supply passage 51. A branch passage side filter 52 for removing dust contained in the low-concentration gas G7 is provided on the branch supply passage 51.

In other words, the intake damper 45 is connected to the downstream side of a branch point P that ramifies the branch supply passage 51 branches from the low-concentration gas passage 22. In order to lower the methane concentration of the low-concentration gas G7, which is the oxidation treatment target, using the air A introduced from the intake damper 45, the position at which the intake damper 45 is connected is not particularly limited as long as the position is between the VAM supply source VS and the mixer 17. However, when the intake damper 45 is connected to the downstream side of the branch point P that ramifies the branch supply passage 51 from the low-concentration gas passage 22 and the air A from an outside is introduced to the downstream side of the branch point P as in the present embodiment, it is possible to avoid lowering of the concentration of the working gas G1 to be supplied to the gas turbine GT, which is a supply source of heat used for the oxidation treatment, and thereby decreasing of the output of the gas turbine GT.

In addition, in order to release, to the outside, the low-concentration gas G7 flowing through the low-concentration gas passage 22, the position at which the blow-off valve 47 is connected is not particularly limited as long as the position is between the VAM supply source VS and the mixer 17. However, in order to more efficiently release the low-concentration gas G7, the blow-off valve 47 may be connected to the upstream side of the flow control valve 41 to blow off the low-concentration gas G7 from the upstream side of the flow control valve 41. Furthermore, in order to avoid a decrease in the output of and stop of the gas turbine GT, the blow-off valve 47 may be connected to the downstream side of the branch point P, from which the branch supply passage 51 branches, to blow off the low-concentration gas G7 from the downstream side of the branch point P. In the system ST according to the present embodiment, it is possible to effectively use exhaust heat from the gas turbine GT, and it is possible to avoid burnout of the catalyst layer 15 even when the concentration of the supplied low-concentration methane gas is varied, since the intake damper 45, the blow-off valve 47, and the like are provided. Thus, it is possible to stably operate the system ST. Furthermore, since the lean fuel intake gas turbine is used as the gas turbine GT, it is possible to also oxidize, by the low-concentration methane gas oxidation device OD, unburned low-concentration gases at the gas turbine GT such as a low-concentration methane gas used to cool the shaft of the turbine 3 and a low-concentration gas which leaks from a minute gap between the components which form the gas turbine GT.

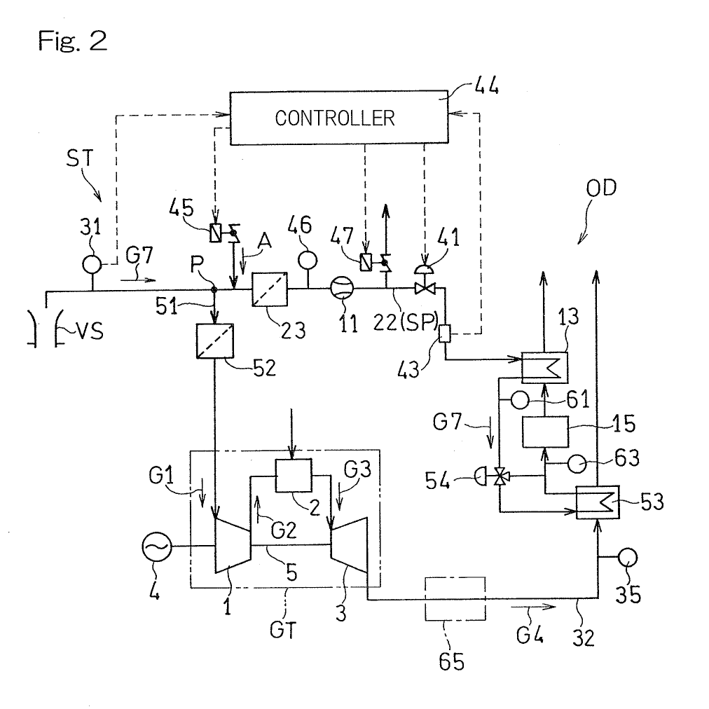

FIG. 2 is a schematic configuration diagram showing an oxidation system ST according to a second embodiment of the present invention. Hereinafter, with regard to the configuration of the present embodiment, difference from the first embodiment will be mainly described. In the present embodiment, a type of a gas turbine in which a fuel F is directly injected to the combustor 2 is used as the gas turbine engine GT. In addition, the exhaust gas from the turbine 3 is not mixed directly with the low-concentration gas which is to be oxidized by the low-concentration methane gas oxidation device OD, and alternatively merely heat exchange is performed between both gases.

Specifically, an exhaust gas heat exchanger 53 is provided on the exhaust gas sending passage 32 through which the exhaust gas from the turbine 3 is discharged. When the low-concentration gas G7 having passed through the second heat exchanger 13 passes through the exhaust gas heat exchanger 53, the low-concentration gas G7 is heated by the heat of the exhaust gas G4. The low-concentration gas G7 having passed through the exhaust gas heat exchanger 53 is oxidized in the catalyst layer 15, subsequently heats the low-concentration gas G7 at the second heat exchanger 13, and then is discharged to the outside of the system.

A passage switching valve 54 is provided on a portion of the low-concentration gas passage 22 which connects the second heat exchanger 13 and the exhaust gas heat exchanger 53. By switching the passage switching valve 54, a passage of the low-concentration gas may be selectively switched between a path allowing the low-concentration gas to flow from the second heat exchanger 13 through the exhaust gas heat exchanger 53 into the catalyst layer 15 and a path allowing the low-concentration gas to flow from the second heat exchanger 13 directly into the catalyst layer 15 without flowing through the exhaust gas heat exchanger 53. Control of the switching of the passage of the low-concentration gas is performed on the basis of temperature measured values of a fourth temperature sensor 61 provided at the downstream side of the second heat exchanger 13 on the low-concentration gas passage 22 and a fifth temperature sensor 63 provided at the upstream side of the catalyst layer 15 on the low-concentration gas passage 22. Specifically, at the time of startup of the low-concentration methane gas oxidation device OD, the passage switching valve 54 is set such that the low-concentration gas G7 passes through the exhaust gas heat exchanger 53, and after that, when the low-concentration gas temperature measured by the fourth temperature sensor 61 becomes higher than the gas temperature measured by the fifth temperature sensor 63, the passage is switched such that the low-concentration gas G7 flows directly into the catalyst layer 15 without passing through the exhaust gas heat exchanger 53.

It should be noted that as a modification of the present embodiment, as indicated by an alternate long and short dash line in FIG. 2, an additional catalyst layer 65 may be provided on the exhaust gas sending passage 32 to increase the treated amount of the low-concentration methane gas at the gas turbine GT side. Alternatively, the branch supply passage 51 from the low-concentration gas passage 22 to the gas turbine GT may be omitted, and air may be introduced as a working gas into the compressor 1.

In the oxidation system ST and the oxidation method according to the present embodiment, the amount of gas to be treated in the catalyst layer 15 is smaller than that in the first embodiment, and thus it is possible to reduce the amount of the catalyst used in the catalyst layer 15.

As described above, in the low-concentration methane gas oxidation system ST according to the present embodiment, even when the VAM or CMM fuel concentration is rapidly varied, it is possible to avoid burnout of the catalyst layer 15 to enable stable operation.

Although the present invention has been described above in connection with the embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 . . . Compressor
2 . . . Catalytic combustor
3 . . . Turbine
4 . . . Generator
6 . . . First heat exchanger
13 . . . Second heat exchanger
15 . . . Catalyst layer
17 . . . Mixer
22 . . . Low-concentration gas passage
45 . . . Intake damper
47 . . . Blow-off valve
GT . . . Gas turbine
SP . . . Supply passage of low-concentration gas
ST . . . Low-concentration methane gas oxidation system
OD . . . Low-concentration methane gas oxidation device

1. A low-concentration methane gas oxidation system to oxidize a low-concentration methane gas by using exhaust heat from a gas turbine engine, the low-concentration methane gas oxidation system comprising:
a supply source of the low-concentration methane gas, which is an oxidation treatment target;
a catalyst layer configured to oxidize the low-concentration methane gas by catalytic combustion; and
an intake damper connected to a supply passage through which the low-concentration methane gas is supplied from the supply source to the catalyst layer and configured to introduce an air from an outside into the supply passage when a methane concentration within the supply passage is higher than a predetermined value.

2. The low-concentration methane gas oxidation system as claimed in claim 1, wherein the supply passage is connected with a blow-off valve configured to release a gas within the supply passage to an outside when the methane concentration within the supply passage is higher than a predetermined value.

3. The low-concentration methane gas oxidation system as claimed in claim 1, wherein the gas turbine engine is a lean fuel intake gas turbine which uses, as a working gas, the low-concentration methane gas supplied from the supply source, and the intake damper is connected to a downstream side of a branch point that ramifies from the supply passage a branch supply passage to supply the low-concentration methane gas to the gas turbine engine.

4. A low-concentration methane gas oxidation method for oxidizing a low-concentration methane gas by using exhaust heat from a gas turbine engine, the low-concentration methane gas oxidation method comprising:
oxidizing the low-concentration methane gas supplied from a supply source, by catalytic combustion; and
introducing an air from an outside into a supply passage through which the low-concentration methane gas is supplied from the supply source, when a methane concentration within the supply passage is higher than a predetermined value.

5. The low-concentration methane gas oxidation method as claimed in claim 4, further comprising releasing a gas within the supply passage to an outside when the methane concentration within the supply passage is higher than the predetermined value.

6. The low-concentration methane gas oxidation method as claimed in claim 4, wherein the gas turbine engine is a lean fuel intake gas turbine which uses, as a working gas, the low-concentration methane gas supplied from the supply source, and the intake damper is connected to a downstream side of a branch point that ramifies from the supply passage a branch supply passage to supply the low-concentration methane gas to the gas turbine engine.
